(19) United States
(12) Patent Application Publication
(10) Pub. No.: US 2005/0004932 A1
(43) Pub. Date: Jan. 6, 2005

(54) Device, a computer network search engine, a personal computer for generating an indication of a relation between a text and a subject reference

(76) Inventor: Peter Nordin, Askim (SE)

Correspondence Address: HARNESS, DICKEY & PIERCE, P.L.C., P.O. BOX 8910, RESTON, VA, 20195, US

(21) Appl. No.: 10/845,334

(22) Filed: May 14, 2004

Related U.S. Application Data
(60) Provisional application No. 60/470,503, filed on May 15, 2003.

(30) Foreign Application Priority Data
Jun. 24, 2003 (SE) 0301808-2

(51) Int. Cl. G06F 17/00

(52) U.S. Cl. 707/102

(57) ABSTRACT

A device is for generating an indication of a relation between a text and a subject reference. The device includes a processor and a memory including the subject reference. The processor is configured for receiving a file containing the text; breaking down the file into file components; identifying control instructions among the file components by comparing the file components to a control instruction reference in a memory; filtering out the identified control instructions; and generating the indication by analysing the remaining text using at least one surface structure text analysis method and the subject reference. A computer network search engine including the device and a personal computer including the device are also disclosed.

The present application hereby claims priority under 35 U.S.C. §119 on Swedish patent application number SE 0301808-2 filed Jun. 24, 2003 and on U.S. provisional application Ser. No. 60/470 503 filed May 15, 2003, the entire contents of each of which are hereby incorporated herein by reference.

### TECHNICAL FIELD

A first aspect of the present invention is generally related to a device for generating an indication of a relation between a text and a subject reference.

A second aspect of the present invention is generally related to a computer network search engine comprising the device.

A third aspect of the present invention is generally related to a personal computer comprising the device.

### BACKGROUND OF INVENTION

Developments in the information technology field over the last decades have lead to increased opportunities of analysing text, and text files, automatically. Word processors are widely spread and they are daily used around the world. The advent of data communication networks, such as the Internet and general electronic mail systems have resulted in an increase of digital documents. In parallel, in today's society using the Internet, the availability of digital information is high.

### SUMMARY OF INVENTION

The present application deals with embodiments of three aspects based on the present invention:
A device for generating an indication of a relation between a text and a subject reference;
A computer network search engine comprising the device; and
A personal computer comprising the device.

According to an embodiment of the first aspect, a device for generating an indication of a relation between a text and a subject reference is disclosed. The device includes a processor and a memory comprises the subject reference.

The subject reference is a reference that indicates the subject in relation to which the text is to be analysed by the device. The subject reference includes a number of features that will be illustrated below.

The processor is configured for receiving a file containing the text. The file may be of any machine-readable media, such as being related to the Internet, an intranet, a digital television set, an electronic mail server. This opens up for a large collection of text in human languages may be collected. Within the scope of the present invention, there is no limitation in terms of the format of the text files. For instance, non-limiting examples may be constituted by a word processor document, an HTML document, a PDF document, and a postscript file.

The processor is configured for breaking down the file into file components. Thus, the file is decomposed into its constituents.

The processor is configured for identifying control instructions among the file components by comparing the file components to a control instruction reference in a memory. The control instruction reference includes one or more sets of control instructions, or control items, for one or more types of e.g. word processors, text-viewing software/document viewing software, printers, and web browsers.

The function of control instructions is to control the internal working of the information technology hardware. Non-limiting examples of information technology hardware include a computer, a printer, a web browser, a personal digital assistant (PDA).

A non-limiting functional example of control instructions is in what way a text is presented on screen, e.g. in terms of font, font size and headings. Other non-limiting ones include ‘carriage return’ and ‘new page’, i.e. instruction to a printer or a word processor to start a new line in the document and to go to a new page, respectively. Also in the web sphere there is a number of control instructions, such as web browser executable programs, a k a scripts.

The processor is configured for filtering out the identified control instructions, leaving the text to be investigated remaining. The processor is configured for generating the indication by analysing the remaining text using at least one surface structure text analysis method and the subject reference.

In a preferred embodiment, the processor is further configured for investigating whether the text is valid for the subject reference.

In a preferred embodiment of the first aspect, the processor is further configured for indicating the indication to a user, or by generating an indication file for later use.

In a preferred embodiment of the first aspect, the processor is further configured for generating a graphic display of the indication in order to visualise the indication making the indication easier to understand.

In a preferred embodiment of the first aspect, the surface structure text analysis method, which may be considered heuristic methods, includes at least one of
keyword analysis,
fuzzy logics,
a regular expression,
a Bayesian network,
a neuron network, and
an evolutionary method.

Methods involving keyword analysis implies that the text is analysed using keywords. The keywords are included in the subject reference. Keyword analysis is primarily used to validate that a document in fact is relevant to the subject of the subject reference.

In one embodiment when a keyword is present in the text then the processor is configured for indicating that a relation between the subject and the text has been found. In reality there is a number of keywords related to the subject and against which the text is investigated. Based on the match between the subject and the keywords, an indication that the text being valid in relation to the subject reference is generated.

Methods involving fuzzy logics are based on a relational mapping between two, or more fuzzy characteristics of words in the subject reference. Methods involving regular expressions deal with words, or combination of words the meaning of which differs from the actual surface structure of the text. Non-limiting examples include irony and idioms.

Methods involving a Bayesian network include classical statistical analysis, such as discriminant analysis and logistic analysis, in which two, or more groups of texts have been generated. The groups may include word pairs, or other groups of words, to which at least one performance notion is associated. The performance notion is related to a word, a combination of a word in the subject reference. Non limiting examples of performance notions include a nominal scale, e.g. positive/negative, a ordinal scale, e.g. 1^{st}, 2^{nd}, 3rd, an interval, e.g. 0.0 to 1.0, and a fraction, e.g. 0.73.

Methods involving application of known neuron networks may also be applied in this context. By simulating the operation of brain cells indications may be generated. Methods involving evolutionary methods, or genetic programming, may also be applied in this context. By inputting a seed an evolutionary method will generate models being the base for categorizing the two, or more groups of texts to be investigated.

In a preferred embodiment of the first aspect, the surface structure text analysis method is at least one of hand coded and produced by at least one machine-learning algorithm.

In a preferred embodiment of the first aspect, the indication is configured for being at least one of: a file, on a screen. Thus the indication may be presented on a screen, or the indication may be written on a file.

According to the second aspect, a computer network search engine comprising the device is disclosed. Due to resemblances between this aspect and the first aspect, and its preferred embodiments, reference is made the first aspect. This aspect indicates the applicability of the first aspect to a computer network search engine for searching for instance the Internet and/or an intranet. For instance, such a computer network search engine may be arranged in a server providing searches on the Internet, or an intranet.

According to the third aspect, a personal computer including the device according to the first aspect is disclosed. This aspect indicates the applicability of the first aspect to a personal computer, or a general-purpose computer.

### BRIEF DESCRIPTION OF THE DRAWINGS

The present invention will become more fully understood from the detailed description of preferred exemplary embodiments given hereinbelow and the accompanying drawings, which are given by way of illustration only and thus are not limitative of the present invention, and wherein:

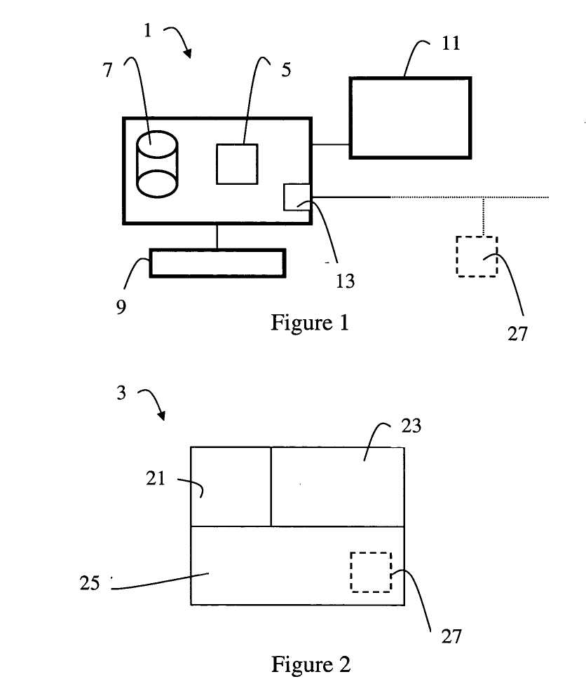

In FIG. 1, a schematic illustration of an embodiment of a device for generating an indication of a relation between a text and a subject reference is disclosed.

In FIG. 2, a schematic illustration of an embodiment of a subject reference is disclosed.

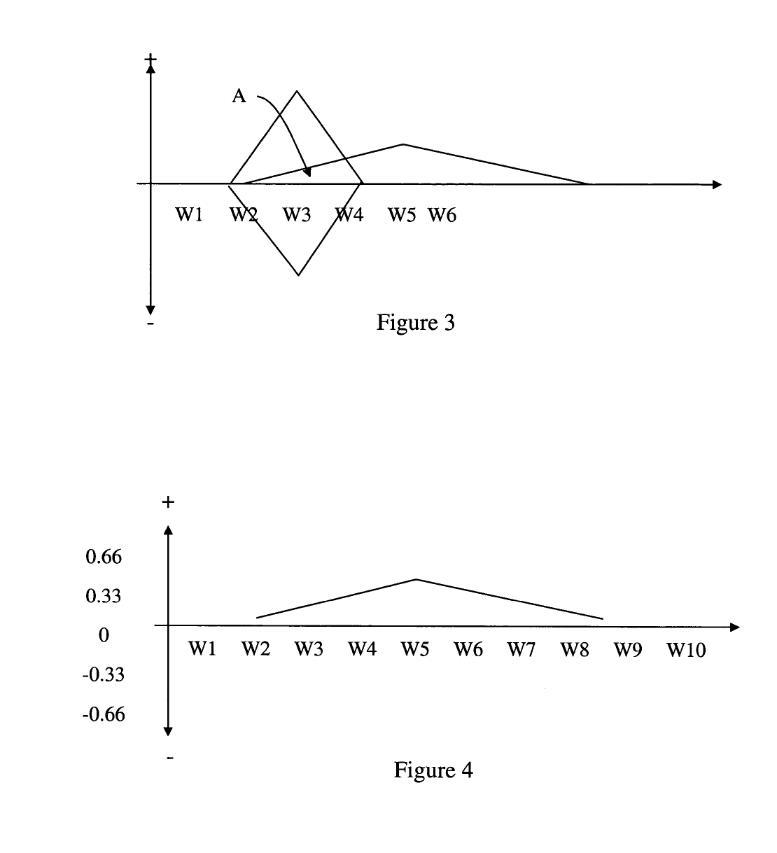

In FIGS. 3 and 4, schematic illustrations of embodiments of surface structures of a sentence are schematically shown.

### DESCRIPTIONS OF PREFERRED EMBODIMENTS

In FIG. 1, a device 1 for generating an indication of a relation between a text and a subject reference 3 is disclosed. The device 1 includes a processor 5 and a memory 7 comprising the subject reference 3.

In a preferred embodiment, the device 1 further includes input device 9, output device 11 and communication capabilities 13 facilitating communication with a computer network, not shown in FIG. 1. The processor 5 is configured for performing the following steps.
Receiving a file containing the text
Breaking down the file into file components
Identifying control instructions among the file components by comparing the file components to a control instruction reference in a memory
Filtering out the identified control instructions
Generating the indication by analysing the remaining text using at least one surface structure text analysis method and the subject reference 3

In a preferred embodiment, the memory comprising the control instruction reference may be in the memory 7, or in another memory accessible using the communication capabilities 13.

In a preferred embodiment, the processor 3 is further configured for indicating the indication to an output device 11.

In FIG. 2, a schematic illustration of a preferred embodiment of the subject reference 3 is given. This preferred embodiment includes three sections, presented below.
A keyword section 21
A regular expression section 23
A word, or phrase, characteristic section 25 including at least one performance notion

The keyword section 21 includes words that are used to validate that it is possible to generate an indication from the text. The regular expression section 23 includes words, or combinations of word, so called phrases, that from a linguistic, or semantic, perspective actually mean something else at a deeper level than at the text surface level. The word characteristic section 25 includes models of the effects on its text surface context from a reader's perspective, i.e. in what way the word has an effect and how strong the effect is on adjacent, or words near that word.

In a preferred embodiment, the control instruction reference is arranged to include control instructions that are related to the internal working of information technology hardware. It may be manifested as a look up table or a database incorporating the control instructions. The control instruction reference 27 is indicated in FIGS. 1 and 2 by dashed lines since its location may be one of the memory 7, or more specifically possible in the subject reference 3, and a remote memory accessible by the device 1 using the communication capabilities 13.

Now a schematic illustration of the first aspect of a configuration of the processor 5 when performing steps above will be given. In this non-limiting preferred embodiment, the employed surface structure text analysis methods are keyword analysis and fuzzy logics.

For patent reasons, regular expressions will not be included since components, e.g. irony and idioms, of the regular expression section 23 are difficult to translate between languages since these components are based on cultural and societal interpretations.

In line with the schematic illustration, an HTML file containing text received by the device 1 presents the contents displayed below. It is assumed that a critic has written the text.

TABLE
An HTML file containing text

<HTML>
<BODY BACKGROUND=″.. \.. \data\Description.jpg″
bgproperties=″fixed″>
<B>Hardware Diagnostics</B><BR>
<BR>
An easy to use diagnostic tool that enables you or our
technicians to run simple and efficient tests to troubleshoot
system difficulties, or to simply get more information about the
system. There is no need of installing or maintaining the tool.
<BR>
Even competitors say that we offer a superior product: “We view
Hardware Diagnostics a leading company in this field today.”
<BR>
Analysts state that investing in Hardware Diagnostics is a
sound investment.
</BODY>
</HTML>

A next step is to investigate whether the text is valid for the subject reference. This is done by checking the contents of the HTML file against the keyword section 21. The keyword section 21 include the words: “hardware”, “diagnos*”, “equipment”. The ‘*’ denote wildcard. Since the HTML file includes at least one of these words, then the HTML file is considered valid.

The next step is to break down the file into file components and identify control instructions by comparing the file components to a control instruction reference in a memory. In the Table below, the contents of the control instruction reference 27 is shown.

TABLE
Non-limiting examples of the contents of the control instruction
reference

<HTML>
<BODY BACKGROUND=″.. \.. \data\Description.jpg″
bgproperties=″fixed″>
<B>
</B>
<BR>
</BODY>
</HTML>

After having filtered out the identified control instructions, the table below shows the remaining text.

TABLE
After having filtered out the identified control instructions, the text
remains

Hardware Diagnostics An easy to use diagnostic tool that
enables you or our technicians to run simple and efficient tests
to troubleshoot system difficulties, or to simply get more
information about the system. There is no need of installing or
maintaining the tool. Even competitors say that we offer a
superior product: “We view Hardware Diagnostics a leading
company in this field today.” Analysts state that investing in
Hardware Diagnostics is a sound investment.

The indication will now be generated by analysing the remaining text using the selected surface structure text analysis method and the subject reference 3. However, only one sentence will analysed for reasons of brevity. In FIG. 3, the surface structure of a sentence, W1, W2, W3, and so on, is schematically shown. The exemplary sentence is as follows.

“We view Hardware Diagnostics a leading company in this field today”.

Here ‘We’ corresponds to W1 in FIG. 3 and ‘view’ to W2 and so on. In the subject reference 3, words, or phrase characteristic for the subject or in general are included. In this case we assume that ‘Hardware Diagnostics’, and ‘leading’ are included the word, or phrase, characteristic section 25 including at least one performance notion. Only a selection of words/phrases is included in this section 25. In FIG. 3, a sequence of words/phrases is indicated along the axis. ‘Hardware Diagnostics’ is W3 and has an effect spilling over to W2 and W4, which is indicated by the rhomboid covering W2 ad W4, completely or at least partly. The word ‘leading’ has a wider effect than ‘Hardware Diagnostics’, which indicated by the triangle being wider than the rhomboid of ‘Hardware Diagnostics’.

A design feature of the fuzzy logic is also the height of the word/phrase. This means that a word/phrase presents two dimensions in this illustrative embodiment. One dimension is the width and the other one is its height. The text structure analysis method is not limited to deal with sentences only, but also to analyse sequences of words/phrases extending over one or more sentences. It does not even have to be a whole sentence but fragments thereof.

In FIG. 3, the mark ‘A’ indicates an area, the size of which corresponds to the strength of the relation between the text, or a fragment of a text, and the subject reference 3. Since the area ‘A’ is above the axis it indicates a positive relation, i.e. the sentence is considered to include a positive feature of Hardware Diagnostics.

In case a word associated with a negative value had occurred in the sentence, then that word would be presented below the axis, as is show in FIG. 4. For instance, the word ‘disaster’ would be corresponding to W5 and having the effect that decreases with an increasing number of words from the word, W5.

It should be pointed out that the effect of the words as described in FIGS. 3 and 4 is based on linear features. However, the present invention is not limited to this case.

By analysing a whole text using the above-mentioned method, leads to an opportunity of adding several areas ‘A’, which may be either positive or negative, together and the sum generated is an indication of the relation between the text and the subject reference 3.

In this preferred embodiment, the subject reference 3 and the surface structure text analysis method are hand coded.

In the embodiment shown in FIG. 3, the indication is an ordinal scale, and in the embodiment shown in FIG. 4, the indication is a fraction.

By analysing a number of text files, it is possible to indicate changes in performance, e.g. over time and in geographical regions, by analysing text files resulting in indications.

In a preferred embodiment, the processor 5 is further configured for generating a graphic display of the indication.

Embodiments of the second and third aspects, i.e. a computer network search engine including the device 1, and a personal computer including the device 1, one or more graphs representations of the sorted data may be generated, for instance, percentage over time of statements that are positive to the subject, volume of messages regarding subject over time, comparisons of opinions between different subjects over time. The graphs may have several different ways of narrowing down the visualizations in terms of plot methods, time intervals, and curves for comparison, such as geographical markets, business segments etc.

Any of the aforementioned methods may be embodied in the form of a program. The program may be stored on a computer readable media and is adapted to perform any one of the aforementioned methods when run on a computer. Thus, the storage medium or computer readable medium, is adapted to store information and is adapted to interact with a data processing facility or computer to perform the method of any of the above mentioned embodiments.

The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Device for generating an indication of a relation between a text and a subject reference, the device comprising a processor and a memory including the subject reference, wherein the processor is configured for
receiving a file containing the text;
breaking down the file into file components;
identifying control instructions among the file components by comparing the file components to a control instruction reference in a memory;
filtering out the identified control instructions; and
generating the indication by analysing the remaining text using at least one surface structure text analysis method and the subject reference.

2. Device according to claim 1, wherein the processor is further configured for investigating whether the text is valid for the subject reference.

3. Device according to claim 1, wherein the processor is further configured for indicating the indication.

4. Device according to claim 1, wherein the control instructions are related to the internal working of information technology hardware.

5. Device according to claim 1, wherein the surface structure text analysis method includes at least one of: keyword analysis, fuzzy logics, at least one regular expression, a Bayesian network, a neuron network, and an evolutionary method.

6. Device according to claim 1, wherein the surface structure text analysis method is at least one of: hand coded, and produced by at least one machine-learning algorithm.

7. Device according to claim 1, wherein the indication is related to one of: a nominal scale, an ordinal scale, an interval, and a fraction.

8. Device according to claim 1, wherein the processor is further configured for generating a graphic display of the indication.

9. Device according to claim 1, wherein the indication is configured for being at least one of: a file, on a screen.

10. A computer network search engine comprising the device according to claim 1.

11. A personal computer comprising the device according to claim 1.

12. A computer network search engine comprising the device according to claim 2.

13. A personal computer comprising the device according to claim 2.

14. A computer network search engine comprising the device according to claim 3.

15. A personal computer comprising the device according to claim 3.

16. A computer network search engine comprising the device according to claim 4.

17. A personal computer comprising the device according to claim 4.

18. A computer network search engine comprising the device according to claim 5.

19. A personal computer comprising the device according to claim 5.

20. Device for generating an indication of a relation between a text and a subject reference, the device comprising:
means for receiving a file containing the text;
means for breaking down the file into file components;
means for identifying control instructions among the file components by comparing the file components to a control instruction reference;
means for filtering out the identified control instructions; and
means for generating the indication by analysing the remaining text using at least one surface structure text analysis method and the subject reference.

21. Device according to claim 20, further comprising at least one memory including at least one of the subject reference and the control instruction reference.

22. A method for generating an indication of a relation between a text and a subject reference, the method comprising:
receiving a file containing the text;
breaking down the file into file components;
identifying control instructions among the file components by comparing the file components to a control instruction reference;
filtering out the identified control instructions; and
generating the indication by analysing the remaining text using at least one surface structure text analysis method and the subject reference.

23. A method according to claim 22, wherein at least one of the subject reference and the control instruction reference is stored in a memory.

24. A program, adapted to perform the method of claim 22, when executed on a computer.

25. A computer readable medium, storing the program of claim 24.
